(19) United States
(12) Patent Application Publication
(10) Pub. No.: US 2017/0166327 A1
(43) Pub. Date: Jun. 15, 2017

(54) LAUNCH AND LANDING PAD FOR DRONES

(71) Applicant: Louis J. Schmidt, San Pedro, CA (US)

(72) Inventor: Louis J. Schmidt, San Pedro, CA (US)

(73) Assignee: Hoodman Corporation, Torrance, CA (US)

(21) Appl. No.: 15/263,484

(22) Filed: Sep. 13, 2016

Related U.S. Application Data
(60) Provisional application No. 62/266,130, filed on Dec. 11, 2015.

(51) Int. Cl. B64F 1/00; B64F 1/04

(52) U.S. Cl. CPC B64F 1/007; B64F 1/04; B64C 2201/127

(57) ABSTRACT

A launch and landing pad for drones includes a flexible base having a perimeter. An endless frame member is joined to the perimeter of the base. The endless frame member is weighted. The weight of the endless frame member holds the pad in place, and the endless frame member is collapsible to fold the pad for storage and releasable for use of the pad.

### CROSS REFERENCE TO RELATED APPLICATION

This application claims the priority of U.S. Provisional Application No. 62/266,130 filed Dec. 11, 2015.

### TECHNICAL FIELD

This invention relates to aerial drones, and more particularly to the launch and landing of drones.

### BACKGROUND OF THE INVENTION

It is known in the art relating to unmanned, flying drone vehicles (also known as unmanned aerial vehicles or unmanned aircraft systems), such as drones that are used for video and photography, that the camera is mounted beneath the drone. Upon take off, the amount of thrust created to lift the drone off the ground causes dust and debris to pummel the video/camera lens prior to the drone becoming airborne. A dirty lens greatly degrades the quality and limits the usefulness of any video or photos captured by the camera during the drone flight.

Conventional drone launch pads placed underneath the drone prior to initiation of flight may protect the camera lens from debris, and also prevent drone rotor damage from tall grass and pebble strikes. Drone launch pads also prevent dirt from being sucked through the motor bearings, which would otherwise lead to motor failure. However, conventional drone launch pads to date have been made of tarps that require stakes to be pounded into the ground to keep the pads from being blown away by or sucked into the drone propellers. Also, if the drone is launched from a cement surface, a rocky surface, or other hard surface, the stakes cannot be used to hold the launch pad tarp.

At the end of a flight, a drone does not always return to the same location as the launch because its GPS system is not precise. In this case, a staked-down tarp that was used for launch cannot be moved in a timely or easy fashion to accommodate a new return landing site.

Other drone pads have been made of carpet, hard plastic, or other bulky materials. However, due to their materials of construction, these pads are not collapsible.

### SUMMARY OF THE INVENTION

The present invention provides a launch and landing pad for drones that is quickly and easily deployed for use and collapsed for storage. The present pad also does not require stakes or other similar securement devices to hold the pad in place, thereby facilitating the deployment of the pad and repositioning of the pad to a different location.

More particularly, a launch and landing pad for drones in accordance with the invention includes a surface member and an endless weighted perimeter disposed along the outer peripheral edge portion of the surface member. The weighted endless perimeter of the surface member maintains the position of the launch and landing pad while in use without a separate securing member. The weighting of the endless perimeter is beneficial to drone operators because the present launch and landing pad does not need to be staked down or secured otherwise with another device.

The endless weighted perimeter may include one of a cable rope and a tubular member, and the endless weighted perimeter may be joined to the surface member. The pad may have a round shape, an elliptical shape or other shape.

A launch and landing pad for drones alternatively may include a flexible base having a perimeter. An endless frame member is joined to the perimeter of the base, and the endless frame member is weighted. The weight of the endless frame member holds the pad in place. Also, the endless frame member is collapsible to fold the pad for storage and releasable for use of the pad.

The flexible base may have a round or elliptical shape, and the flexible base may be generally planar in an unfolded use disposition. The flexible base may be a textile material or a flexible plastic material. To join the endless frame member to the flexible base, the endless frame member may be retained in a pocket formed by the perimeter of the flexible base. The flexible base may have a diameter that exceeds a thrust diameter of a drone, providing a clean upper surface area that is larger than the area of thrust of the drone, so that a lens of a camera mounted on the drone will remain clean when the drone is launched from or landed on the pad.

The endless frame member may be a cable rope material which is collapsible but springs back to a non-collapsed disposition. Alternatively, the endless frame member may be tubular, and the tubular endless frame member may contain a solid or liquid filler material. The endless frame member may be collapsible from an unfolded use disposition to a storage disposition that is a fraction of a size of the unfolded disposition.

A method of storing and deploying a launch and landing pad for drones includes the steps of providing a launch and landing pad including a flexible base having a perimeter, and an endless frame member joined to the perimeter of the flexible base, the endless frame member being weighted and collapsible; manipulating the launch and landing pad from an unfolded use disposition to a storage disposition by twisting the endless frame member and folding the twisted endless frame member over itself from a single shape into two or more smaller, similar shapes; and releasing the launch and landing pad from the folded storage disposition, whereby the endless frame member is returnable to the single shape to place the launch and landing pad in the unfolded use disposition.

Optionally, the method may include inserting the folded launch and landing pad into a storage bag. The method also may include positioning the launch and landing pad by grasping the launch and landing pad at the perimeter and tossing the launch and landing pad onto a surface. Additionally, the method may include repositioning the launch and landing pad by removing the launch and landing pad from the surface and tossing the launch and landing pad into another location.

These and other features and advantages of the invention will be more fully understood from the following detailed description of the invention taken together with the accompanying drawings.

### BRIEF DESCRIPTION OF THE DRAWINGS

In the drawings:

FIG. 1 is a perspective view of a launch and landing pad for drones in accordance with the invention in an unfolded, use disposition;

FIG. 2 is a cross-sectional view of the launch and landing pad taken along the line 2-2 in FIG. 1;

FIG. 3 is a cross-sectional view of another launch and landing pad in accordance with the invention;

FIG. 4 is an environmental view of a user holding the launch and landing pad of FIG. 1 in a vertical position to begin collapsing the pad;

FIG. 5 is an environmental view of the user beginning to collapse the launch and landing pad from the unfolded, use disposition into a collapsed, storage disposition by bending the pad;

FIG. 6 is an environmental view of the user twisting the bent launch and landing pad;

FIG. 7 is an environmental view of the user further twisting the launch and landing pad so that one side of the pad overlaps another side;

FIG. 8 is an environmental view of the user beginning to fold the bent and twisted pad into smaller shapes;

FIG. 9 is an environmental view of the user continuing to fold the launch and landing pad;

FIG. 10 is an environmental view of the launch and landing pad folded into the collapsed, storage disposition;

FIG. 11 is an environmental view of the user inserting the collapsed launch and landing pad into a storage bag; and

FIG. 12 is an environmental view of the user carrying the storage bag for transport of the collapsed launch and landing pad.

### DETAILED DESCRIPTION OF THE INVENTION

Referring now to the drawings in detail, numeral 10 generally indicates a launch and landing pad for drones in accordance with the invention. The launch and landing pad is quickly and easily deployed for use and collapsed into a compact configuration for storage, and is easily moved from one location to another. The launch and landing pad also holds itself in place without stakes or other securement devices, so that thrust from the drone or other forces (e.g. wind) does not move the pad during launch or landing of a drone, and the pad protects against debris or other objects contacting a drone upon launch and landing.

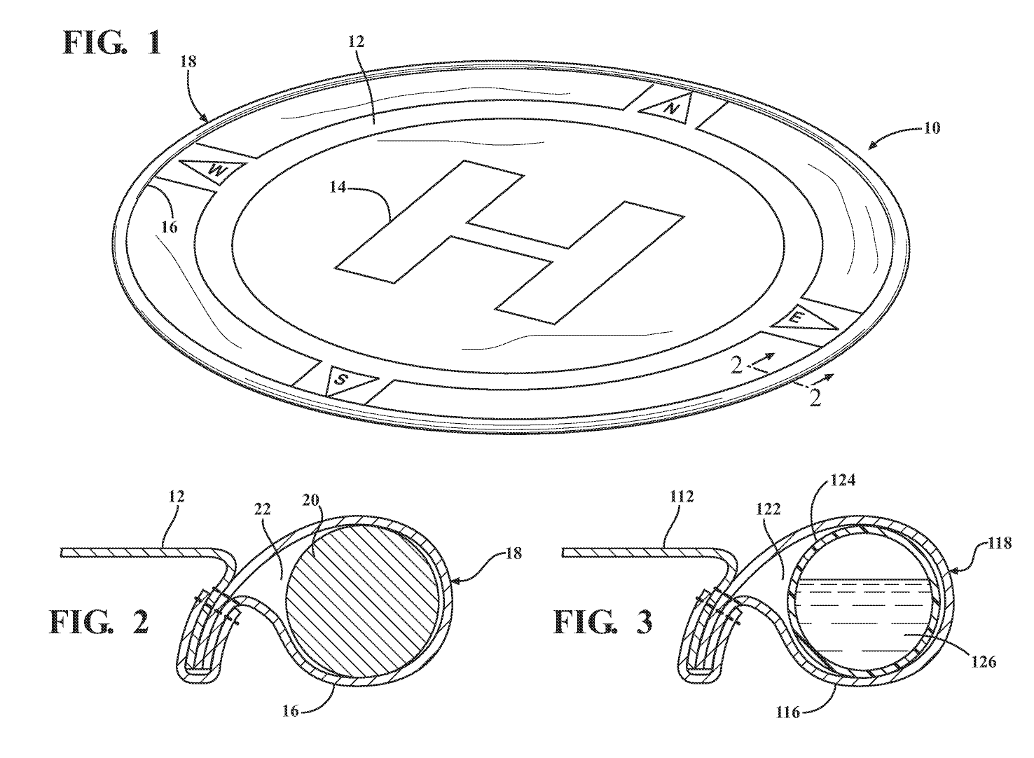

As shown in FIGS. 1 and 2, the launch and landing pad 10 includes a surface member 12 that forms a base or main body of the pad. The surface member may be made of a textile or flexible plastic material such as polyester, or other similar flexible or semi-flexible material, although the material alternatively may be generally rigid. The shape of the surface member 12 is not particularly limited, and the surface member may have an elliptical shape such as an ellipse or circle, an oval shape, a round shape or other similar curved shape. However, the surface member alternatively may have a quadrilateral shape such as a rectangle or square, or a polygonal shape. Regardless of the shape of the surface member, the surface member may generally be planar in an unfolded disposition. The surface member may also include a centrally disposed locating mark 14 such as a letter “H” or other similar heliport marking(s) to aid in positioning a drone during launch and landing. Additionally, the surface member may include compass heading markings.

The surface area of a side (e.g., top side) of the surface member 12 of the pad may exceed the thrust diameter of a drone that is disposed on or above the top side of the pad. This provides a clean upper surface area that is larger than the area of thrust of the drone, so that a lens of a camera mounted on the drone will remain clean when the drone is launched from or landed on the pad 10. In other words, the pad 10 is sized so that the outward thrust of air from a fan, propeller, engine, or other propulsion mechanism of the drone may not move air beyond the perimeter of the pad. For example, the diameter of the circular pad 10 (e.g., three, five, or eight feet) may be wider than the flow of air generated by the drone in a direction towards the perimeter of the pad. Alternatively, in a case that the pad is an ellipse, the length of the major and minor axes of the pad may be greater than a flow of air generated by the drone. Thus, the thrust of the drone upon takeoff and landing does not move any debris (dirt, sand, pebbles, stones, grass, small objects, and the like) that lies outside the clean surface of the pad, and the pad remains clean so that no debris comes into contact with the drone. In addition to protecting any camera mounted on the drone, this feature may also protect the working parts of the drone such as the rotors and motor bearings from damage that could be caused by tall grass in the launch/landing area or by debris that could be “kicked up” during launch or landing.

The surface member 12 has an outer peripheral edge portion 16 that outlines the shape of the surface member. An endless weighted perimeter 18 is disposed along the outer peripheral edge of the surface member. The endless weighted perimeter 18 provides the pad 10 with substantial weight in an amount of pounds. For example, the material forming the surface member 12 may be a lightweight material, and the endless weighted perimeter 18 may have a weight in the range of three to ten pounds. The weight of the endless weighted perimeter may vary depending on the size of the surface member 12. In any event, the weight and disposition of the endless weighted perimeter 18 holds the pad against any ground surface and inhibits movement of the pad due to wind, drone thrust, and the like. The endless weighted perimeter 18 also maintains the position of the surface member 12 when the pad 10 is in use without the need for separate securing member(s) such as stakes or similar to hold the pad in place on the ground. Because the pad 10 does not need to be staked or held to the ground by a separate member, the endless weighted perimeter also allows the pad 10 to be easily moved from one location to another, as described in more detail below. The endless weighted perimeter 18 may be flexible, however the endless weighted perimeter may also have at least a degree of rigidity in order to maintain the shape of the pad 10 during use, and the endless weighted perimeter alternatively may be generally rigid. The weight of the endless perimeter holds the pad in place, but with the surface member and endless perimeter having flexibility characteristics, the pad 10 becomes collapsible. Being collapsible, the pad can be easily folded for storage and unfolded for use.

For example, as shown in FIG. 2 the endless weighted perimeter 18 may include an endless frame member formed of a cable rope 20 such as a flexible steel cable rope hoop, spring steel, a zinc-coated flexible metallic hoop, or similar endless metallic or non-metallic cable rope material that is capable of being bent and folded but returns to its original disposition when released. The peripheral edge portion 16 may include a separate piece of material, and the cable rope 20 may be joined to the surface member 12 by folding the separate piece of material around the cable rope and sewing the folded material to the perimeter of the surface member to form a sealed pocket 22 that retains the cable rope. Alternatively to sewing, the pocket may be formed by adhering or otherwise attaching the peripheral edge portion to itself, for example using glue or other adhesive, snaps, or a hook-and-loop type fastener. The separate piece of material forming the pocket 22 may be a protective material that is more durable and less likely to snag or tear in comparison to a woven textile or alternatively may be the same material as the surface member. Also, an additional protective layer of a material different than the material of the surface member may be sewn or otherwise attached to the outside of the peripheral edge portion to improve the durability of the pad. In yet another alternative, the cable rope may be joined to the surface member by simply folding the perimeter of the surface member around the cable rope and sewing or otherwise attaching the surface member to itself to form the sealed pocket.

Alternatively, as shown in FIG. 3 the endless weighted perimeter 118 may include an endless frame member 124 that is tubular, such as a flexible or semi-flexible hollow tube, bladder, or similar. The tube or bladder may be retained in a pocket 122 formed by the peripheral edge portion 116. The tube or bladder may also include an open and closable opening such as a valve or similar that allows the tube or bladder to be filled with a solid or liquid filler material 126 such as water, dirt, sand, shot, stones, or other weighted material in order to impart weight to the perimeter of the surface member 112. When the pad is not in use, the filler material 126 may be removed from the endless frame member 124.

In yet another alternative, the endless weighted perimeter may be integrally formed with the surface member.

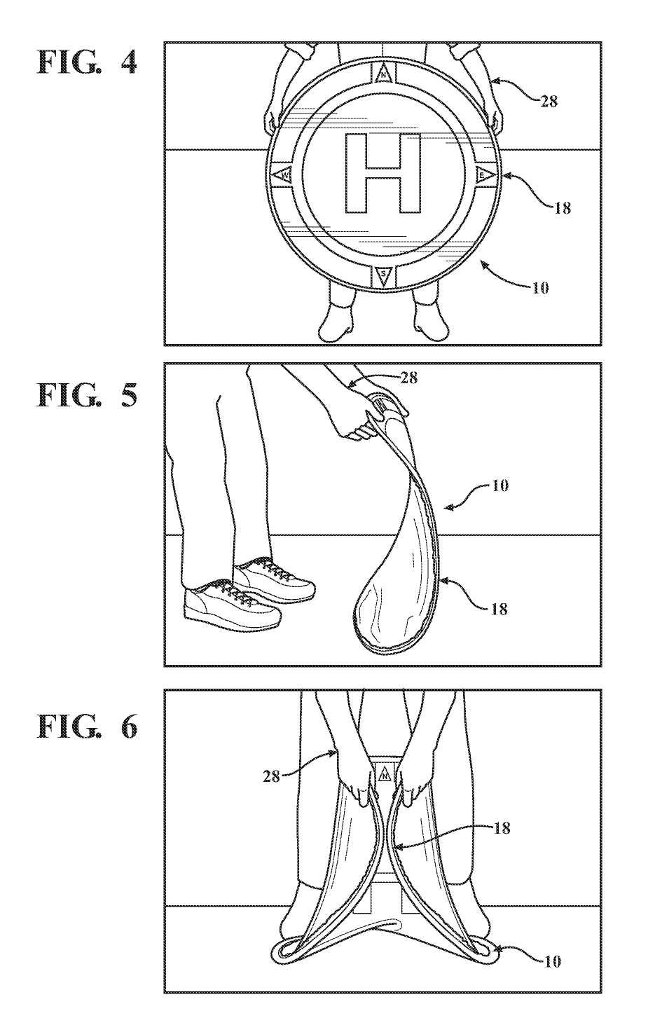

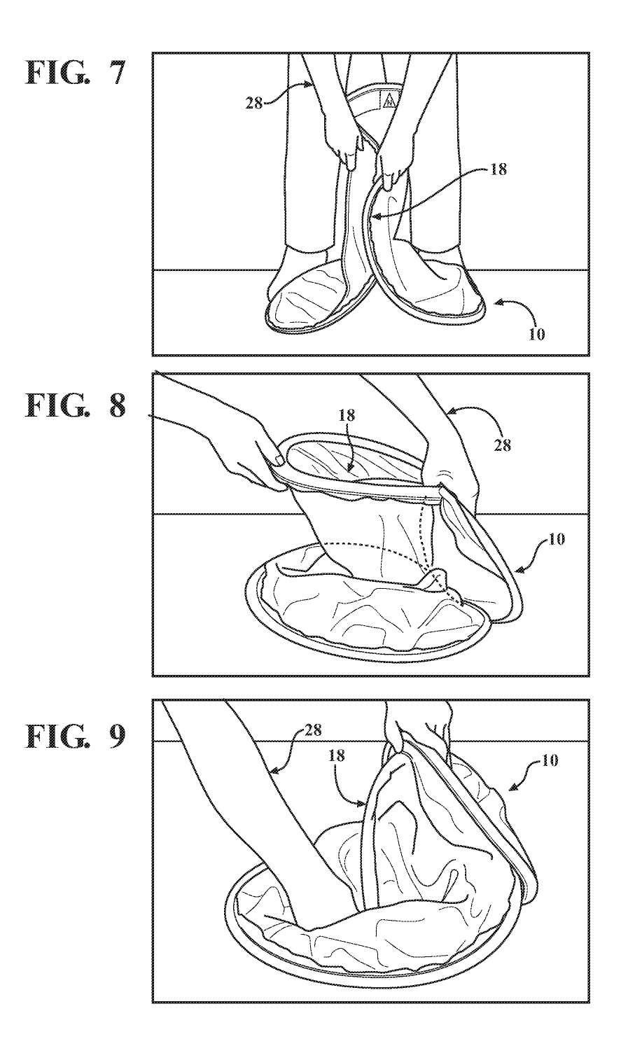

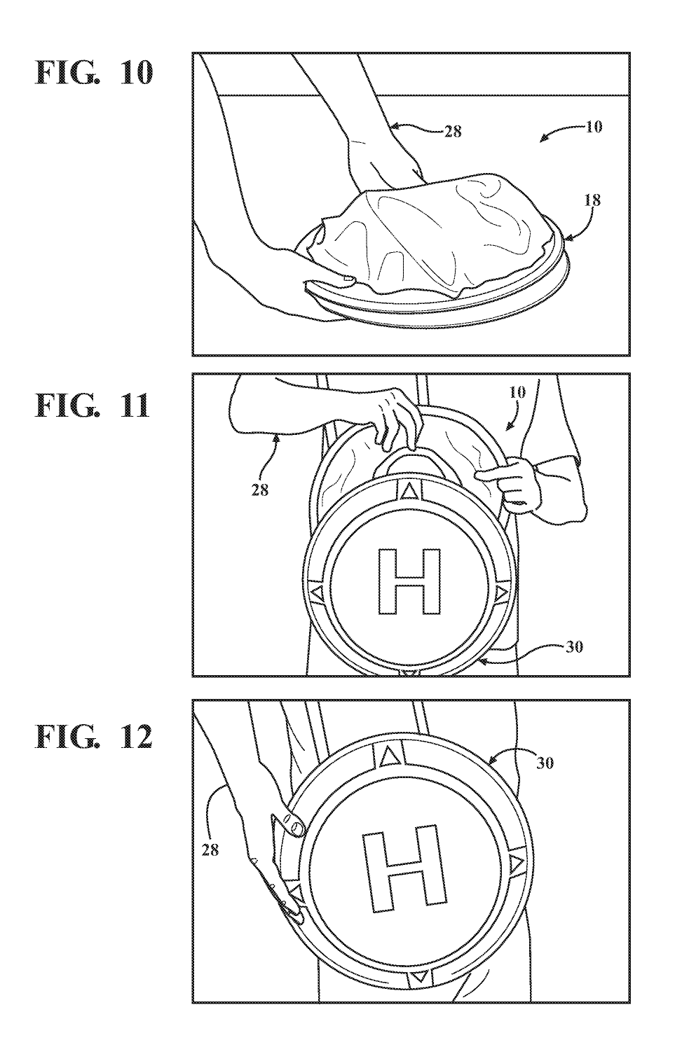

The endless weighted perimeter 18 may provide for simple and easy storage and deployment of the pad 10. For example, the endless weighted perimeter may be collapsible (e.g., cable rope or flexible bladder) to allow the pad to be folded from an unfolded use disposition, in which the surface member is deployed to its full size, into a storage disposition that is a fraction (generally ⅓^{rd} , depending on the shape) of the size of the pad in the unfolded use disposition. The precise method of collapsing the pad may vary depending upon the size of the pad. However, in the case that the endless weighted perimeter includes a cable rope, collapsing or folding the pad 10 for storage requires two main steps, the first step including bending and twisting the endless weighted perimeter 18 and the second step including folding the twisted endless weighted perimeter into a plurality of similar shapes that are smaller than the original fully open shape of the pad. For example, turning to FIG. 4, in order to collapse the pad 10 a user 28 picks the pad up with both hands and grasps the endless weighted perimeter 18 with arms extended so that his or her hands are as far apart as possible and the pad is disposed generally vertical with respect to the ground. Next, as shown in FIGS. 5-7, the user 28 manipulates the pad 10 by pulling both hands towards each other to bend and twist the endless weighted perimeter from its original full single shape to a tubular-like shape in which part of the upper surface of the pad 10 overlaps part of the lower surface of the pad. Then, as shown in FIGS. 8-10, the user 28 folds the twisted endless weighted perimeter over itself into two or more smaller, similar shapes by folding end portions of the twisted pad underneath the overlapping center portion to completely collapse the pad 10. For example, twisting and folding the endless weighted perimeter may collapse the pad from its original large circular shape (e.g., a circle having a diameter of three feet) into three smaller circular shapes that are a fraction of the original size of the pad 10 as shown in FIG. 10 (e.g., three smaller circles each having a diameter of thirteen inches). Once in the collapsed (folded) storage disposition, the pad 10 may be inserted into and stored in a storage bag 30 as shown in FIG. 11. Alternatively, the pad may be held in the collapsed disposition by being tied, strapped or otherwise secured with any suitable fastener. The storage bag 30 may include a handle and/or a shoulder strap that allows for easy carrying and transport of the storage bag and collapsed pad as shown in FIG. 12.

The pad 10 is also easily deployable for use. When the pad 10 is removed from the storage bag 30 by the user, the pad is unfolded by releasing it from its folded storage disposition and opening the endless weighted perimeter back to its original, deployed use disposition. More specifically, the pad may be released from the storage disposition by the user unfolding the pad and removing his or her grip on the pad, whereby the endless frame member is returnable to its original unfolded single shape to place the launch and landing pad in the use disposition. In the case that the weighted endless perimeter is the aforementioned cable rope material, the pad may spring back to its unfolded shape without user assistance. Once in the use disposition, the pad may be positioned and repositioned by hand by the user grasping the pad at the perimeter and placing, tossing or throwing the pad onto various surfaces. The endless weighted perimeter is heavy enough to keep the pad in a single position, but it is also light enough that a user is able to easily pick the pad up and reposition it. The weighted endless perimeter moves along with the pad allowing for deployment and securement of the pad on grass, dirt, roads, cement, a floor, a tarmac, and the like. The pad may also conform to non-flat and/or uneven terrain.

Once the pad 10 is deployed onto a surface in its use disposition, the user may place a drone on top of the pad. The locating mark 14 may aid the user in centering the drone on the pad. The user can then launch the drone from the pad. The user may leave the pad in place for later landing of the drone. If the drone is equipped with a GPS feature, the drone may return to the same location for landing. However, the drone GPS may be slightly inaccurate by a few feet, and as the drone approaches the pad for landing, it may be necessary for the user to adjust the positioning of the pad. As described above, the pad is quickly and easily repositioned by the user simply lifting the pad off the ground and tossing or placing the pad in another location. Also, if the drone does not have a GPS feature, if the drone's GPS intermittently fails, or if the sudden need for a quick “emergency” landing arises, the user can easily move the pad to any other location for landing of the drone. In the case that the user manually lands the drone, the locating mark 14 can be used as a guide to bring the drone down onto the center of the pad. When the user is finished using the pad, the user can return the pad to the storage disposition.

Although the invention has been described by reference to specific embodiments, it should be understood that numerous changes may be made within the spirit and scope of the inventive concepts described. Accordingly, it is intended that the invention not be limited to the described embodiments, but that it have the full scope defined by the language of the following claims.

What is claimed is:

1. A launch and landing pad for drones, said pad comprising:
a surface member having an outer peripheral edge portion; and
an endless weighted perimeter disposed along said outer peripheral edge portion of said surface member;
wherein said endless weighted perimeter maintains a position of said surface member without a separate securing member.

2. The launch and landing pad of claim 1, wherein said endless weighted perimeter includes one of a cable rope and a tubular member.

3. The launch and landing pad of claim 1, wherein said endless weighted perimeter is joined to said surface member.

4. The launch and landing pad of claim 1, wherein said pad has one of a round shape and an elliptical shape.

5. A launch and landing pad for drones, said pad comprising:
a flexible base having a perimeter; and
an endless frame member joined to the perimeter of said base;
said endless frame member being weighted;
wherein the weight of said endless frame member holds said pad in place, and said endless frame member is collapsible to fold said pad for storage and releasable for use of said pad.

6. The launch and landing pad of claim 5, wherein said flexible base has one of a round shape and an elliptical shape.

7. The launch and landing pad of claim 5, wherein said flexible base is generally planar in an unfolded use disposition.

8. The launch and landing pad of claim 5, wherein said flexible base is one of a textile material and a flexible plastic material.

9. The launch and landing pad of claim 5, wherein said endless frame member is retained in a pocket formed by the perimeter of said flexible base.

10. The launch and landing pad of claim 5, wherein said endless frame member is a cable rope material, which is collapsible but springs back to a non-collapsed disposition.

11. The launch and landing pad of claim 5, wherein said endless frame member is tubular.

12. The launch and landing pad of claim 11, wherein said endless frame member contains a solid or liquid filler material.

13. The launch and landing pad of claim 5, wherein said endless frame member is collapsible from an unfolded use disposition to a storage disposition that is a fraction of a size of the unfolded disposition.

14. The launch and landing pad of claim 5, wherein said flexible base has a diameter that exceeds a thrust diameter of a drone.

15. A method of storing and deploying a launch and landing pad for drones, said method comprising the steps of:
providing a launch and landing pad including a flexible base having a perimeter, and an endless frame member joined to said perimeter of said flexible base, said endless frame member being weighted and collapsible;
manipulating said launch and landing pad from an unfolded use disposition to a storage disposition by twisting said endless frame member and folding the twisted endless frame member over itself from a single shape into two or more smaller, similar shapes; and
releasing said launch and landing pad from the folded storage disposition, whereby said endless frame member is returnable to the single shape to place said launch and landing pad in the unfolded use disposition.

16. The method of claim 15, further including the step of:
inserting the folded launch and landing pad into a storage bag.

17. The method of claim 15, further including the steps of:
grasping said launch and landing pad at said perimeter; and
tossing said launch and landing pad onto a surface.

18. The method of claim 17, further including the steps of:
repositioning said launch and landing pad by removing said launch and landing pad from said surface and tossing said launch and landing pad into another location.
